(19) United States
(12) Patent Application Publication
(10) Pub. No.: US 2024/0106962 A1
(43) Pub. Date: Mar. 28, 2024

(54) IMAGE READING DEVICE AND IMAGE FORMING APPARATUS

(71) Applicant: FUJIFILM Business Innovation Corp., Tokyo (JP)

(72) Inventors: Masakazu SHIRAI, Kanagawa (JP); Taketoshi TANAKA, Kanagawa (JP); Akio SHIMONAGA, Kanagawa (JP); Masaaki TAKENOUCHI, Kanagawa (JP); Takuma AYABE, Kanagawa (JP)

(73) Assignee: FUJIFILM Business Innovation Corp., Tokyo (JP)

(21) Appl. No.: 18/188,468

(22) Filed: Mar. 23, 2023

(30) Foreign Application Priority Data
Sep. 22, 2022 (JP) 2022-151450

(51) Int. Cl. H04N 1/401; H04N 1/00

(52) U.S. Cl. CPC H04N 1/401; H04N 1/00819

(57) ABSTRACT

An image reading device includes a reading unit that reads an image on a surface of a medium; and a calibrating unit that is disposed to face the reading unit with the medium disposed therebetween and that calibrates the reading unit. The calibrating unit is supported such that the calibrating unit is movable about a rotating shaft between a closing position at which the calibrating unit faces the reading unit and an opening position at which the calibrating unit is separated from the reading unit. The calibrating unit is positioned with respect to the reading unit when the calibrating unit is moved to the closing position.

### CROSS-REFERENCE TO RELATED APPLICATIONS

This application is based on and claims priority under 35 USC 119 from Japanese Patent Application No. 2022-151450 filed Sep. 22, 2022.

### BACKGROUND

### (i) Technical Field

The present disclosure relates to an image reading device and an image forming apparatus.

### (ii) Related Art

Japanese Unexamined Patent Application Publication No. 2016-009933 (see [0070]-[0095] and FIGS. 1 to 3), hereinafter referred to as Patent Document 1, describes an image reading device that is included in an image forming apparatus and that reads an image formed on a medium surface to detect an image defect.

According to the technology described in Patent Document 1, a built-in image sensor (200) reads an image on a recording medium (P) to detect whether the image is defective. Patent Document 1 describes a structure in which a setting unit (210) is disposed to face the built-in image sensor (200) with the recording medium (P) disposed therebetween and in which the setting unit (210) includes a reference roller (226) used to correct a charge-coupled-device (CCD) sensor (204).

### SUMMARY

Aspects of non-limiting embodiments of the present disclosure relate to an improvement of the accuracy of positioning a calibrating unit and a reading unit compared to when the reading unit and the calibrating unit are brought into contact with and separated from each other by drawing out and inserting one of the reading unit and the calibrating unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image reading device including: a reading unit that reads an image on a surface of a medium; and a calibrating unit that is disposed to face the reading unit with the medium disposed therebetween and that calibrates the reading unit, wherein the calibrating unit is supported such that the calibrating unit is movable about a rotating shaft between a closing position at which the calibrating unit faces the reading unit and an opening position at which the calibrating unit is separated from the reading unit, and wherein the calibrating unit is positioned with respect to the reading unit when the calibrating unit is moved to the closing position.

### BRIEF DESCRIPTION OF THE DRAWINGS

An exemplary embodiment of the present disclosure will be described in detail based on the following figures, wherein:

FIG. 1 illustrates the overall structure of an image forming apparatus according to an exemplary embodiment;

FIG. 2 illustrates a test device according to the exemplary embodiment;

FIG. 3 illustrates operation units of the test device according to the exemplary embodiment;

FIG. 4 illustrates the relationship between an upstream sensor unit and a frame unit;

FIG. 5 is a perspective view of an end portion of the upstream sensor unit; and

FIGS. 6A and 6B illustrate forces applied to handles according to the exemplary embodiment, wherein FIG. 6A illustrates forces applied to a first handle and FIG. 6B illustrates forces applied to a second handle.

### DETAILED DESCRIPTION

While an exemplary embodiment of the present disclosure will be described with reference to the drawings, the present disclosure is not limited to the exemplary embodiment described below.

To facilitate understanding of the following description, in each figure, the front-back direction (medium width direction), the left-right direction (medium transporting direction), and the up-down direction are defined as the X-axis direction, the Y-axis direction, and the Z-axis direction, respectively. In addition, the directions shown by arrows X, −X, Y, −Y, Z, and −Z are defined as forward, backward, rightward, leftward, upward, and downward, respectively, and sides in those directions are defined as the front side, the back side, the right side, the left side, the top side, and the bottom side, respectively.

In addition, in each figure, a circle with a dot in the middle represents an arrow coming out of the page, and a circle with an X in the middle represents an arrow going into the page.

In the drawings, components other than those to be described with reference to the drawings are omitted as appropriate to facilitate understanding.

### Exemplary Embodiment

### Description of Overall Structure of Printer U of Exemplary Embodiment

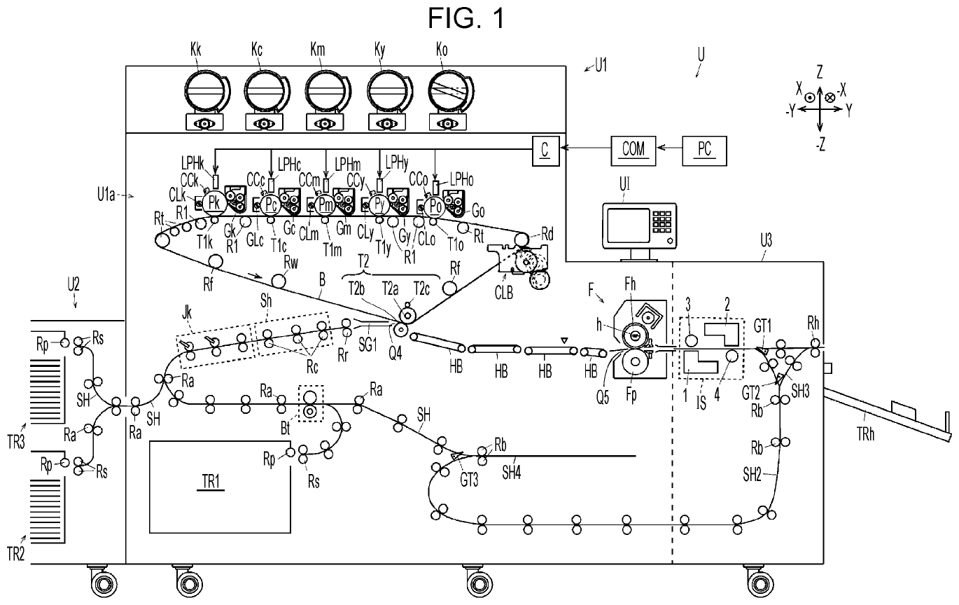

FIG. 1 illustrates the overall structure of an image forming apparatus according to an exemplary embodiment.

Referring to FIG. 1, a printer U, which is an example of an image forming apparatus according to the exemplary embodiment of the present disclosure, includes a printer body U1; a feeder unit U2, which is an example of a supply device that supplies a medium to the printer body U1; an operation unit UI operated by a user; and a finisher U3, which is an example of a post-processing device that performs post-processing on the medium output from the printer body U1.

### Description of Marking Structure of Exemplary Embodiment

Referring to FIG. 1, the printer body U1 includes a controller (example of a control unit) C that controls the printer U; a communication unit (not illustrated) that receives image information transmitted from a print image server COM, which is an example of an information transmission device connected to a unit outside the printer U by a dedicated cable (not illustrated); and a marking unit U1a, which is an example of a recording unit that records an image on the medium. The print image server COM is connected by a cable or a network, such as a local area network (LAN), to a personal computer PC, which is an example of an image transmission device that transmits information of an image to be printed by the printer U.

The marking unit U1a includes photoconductors Py, Pm, Pc, and Pk, which are examples of image carriers for respective colors, which are yellow (Y), magenta (M), cyan (C), and black (K), and a photoconductor Po used to make an image glossy when, for example, a photographic image is printed. The photoconductors Py to Po are each made of a dielectric having a photosensitive surface.

Referring to FIG. 1, a charging device CCk, an exposure device LPHk, a developing device Gk, a first transfer roller T1k, and a photoconductor cleaner CLk, which are examples of a charging unit, a latent-image forming unit, a developing unit, a first transfer unit, and an image-carrier cleaning unit, respectively, are arranged around the black photoconductor Pk in that order in a direction in which the photoconductor Pk rotates.

Similarly, charging devices CCy, CCm, CCc, and CCo, exposure devices LPHy, LPHm, LPHc, and LPHo, developing devices Gy, Gm, Gc, and Go, first transfer rollers T1y, T1m, T1c, and T1o, and photoconductor cleaners CLy, CLm, CLc, and CLo are disposed around the other photoconductors Py, Pm, Pc, and Po.

Toner cartridges Ky, Km, Kc, Kk, and Ko, which are examples of containers for developers, are removably supported above the marking unit U1a. Developers to be supplied to the developing devices Gy to Go are contained in the toner cartridges Ky to Ko.

An intermediate transfer belt B, which is an example of an intermediate transfer unit and which is also an example of an image carrier, is disposed below the photoconductors Py to Po. The intermediate transfer belt B is disposed between each of the photoconductors Py to Po and a corresponding one of the first transfer rollers T1y to T1o. The inner surface of the intermediate transfer belt B is supported by a driving roller Rd, which is an example of a driving unit; a tension roller Rt, which is an example of a tension-applying unit; a walking roller Rw, which is an example of a meandering prevention unit; plural idler rollers Rf, which are examples of driven units; a backup roller T2a, which is an example a second-transfer facing unit; plural retractable rollers R1, which are examples of movable units; and the first transfer rollers T1y to T1o.

A belt cleaner CLB, which is an example of an intermediate-transfer-unit cleaning unit, is disposed on the outer surface of the intermediate transfer belt B at a position close to the driving roller Rd.

A second transfer roller T2b, which is an example of a second transfer member, faces the backup roller T2a with the intermediate transfer belt B disposed therebetween. A contact roller T2c, which is an example of a contact unit, is in contact with the backup roller T2a to apply a voltage of the same polarity as the charging polarity of the developers to the backup roller T2a.

The backup roller T2a, the second transfer roller T2b, and the contact roller T2c constitute a second transfer device T2, which is an example of a second transfer unit according to the exemplary embodiment. The first transfer rollers T1y to T1o, the intermediate transfer belt B, the second transfer device T2, and other components constitute a transfer apparatus T1, B, T2, which is an example of a transfer unit according to the exemplary embodiment.

A paper feed tray TR1, which is an example of a container, is provided below the second transfer device T2. Recording sheets S, which are examples of media, are stored in the paper feed tray TR1. A pick-up roller Rp, which is an example of a pick-up unit, and separation rollers Rs, which are examples of separation units, are disposed in an upper right region of the paper feed tray TR1. A transport path SH, along which the recording sheets S are transported, extends from the separation rollers Rs. Plural transport rollers Ra, which are examples of transport units that transport the recording sheets S downstream, are arranged along the transport path SH.

A deburring device Bt, which is an example of an unnecessary-portion-removing unit, is disposed downstream of the separation rollers Rs. The deburring device Bt performs deburring, which is a process of removing unnecessary portions at the edges of each recording sheet S by transporting the recording sheet S downstream while nipping the recording sheet S at a preset pressure.

A double-feeding detection device Jk is disposed downstream of the deburring device Bt. The double-feeding detection device Jk measures the thickness of the recording sheets S that pass therethrough to detect double feeding, which is a state in which multiple recording sheets S are transported in an overlapping state.

Correction rollers Rc, which are examples of position correction units, are disposed downstream of the double-feeding detection device Jk. The correction rollers Rc correct a skew, that is, an inclination of each recording sheet S with respect to the transporting direction.

Registration rollers Rr, which are examples of adjustment units that adjust the time at which each recording sheet S is transported to the second transfer device T2, are disposed downstream of the correction rollers Rc. A sheet guide SG1, which is an example of a medium guide unit, is disposed downstream of the registration rollers Rr.

The feeder unit U2 also includes paper feed trays TR2 and TR3 and other components that are structured similarly to the paper feed tray TR1, the pick-up roller Rp, the separation rollers Rs, and the transport rollers Ra, and a transport path SH that extends from the paper feed trays TR2 and TR3 joins the transport path SH in the printer body U1 at a position upstream of the double-feeding detection device Jk.

Plural transport belts HB, which are examples of medium transport units, are disposed downstream of the second transfer roller T2b in the transporting direction of the recording sheet S.

A fixing device F, which is an example of a fixing unit, is disposed downstream of the transport belts HB in the transporting direction of the recording sheet S.

A test device IS, which is an example of an image reading device, is disposed in the finisher U3, which is located downstream of the fixing device F.

A transport path SH that extends toward an output tray TRh, which is an example of a stacking unit, is provided downstream of the test device IS. Output rollers Rh, which are examples of output units, are disposed at the downstream end of the transport path SH.

A reversing path SH2, which is an example of a transport path that branches from the transport path SH, is provided downstream of the test device IS. A first gate GT1, which is an example of a transporting-direction-switching unit, is disposed at the branching point at which the reversing path SH2 branches from the transport path SH.

The reversing path SH2 has plural switchback rollers Rb, which are examples of transport units that are rotatable in forward and reverse directions. A connection path SH3 is provided upstream of the switchback rollers Rb as an example of a transport path that branches from an upstream portion of the reversing path SH2 and joins the transport path SH at a position downstream of the branching point at which the reversing path SH2 branches from the transport path SH. A second gate GT2, which is an example of a transporting-direction-switching unit, is disposed at the branching point at which the connection path SH3 branches from the reversing path SH2.

A switchback path SH4, which is disposed downstream of the reversing path SH2 and below the fixing device F, is used to reverse the transporting direction of the recording sheet S, that is, to transport the recording sheet S in a switchback manner. The switchback path SH4 has switchback rollers Rb, which are examples of transport units that are rotatable in forward and reverse directions. In addition, a third gate GT3, which is an example of a transporting-direction-switching unit, is disposed is at the entrance of the switchback path SH4.

A transport path SH disposed downstream of the switchback path SH4 joins the transport path SH that extends from the paper feed tray TR1.

### Marking Operation

The printer U starts a job, which is an image forming operation, when the printer U receives image information transmitted from the personal computer PC through the print image server COM. When the job is started, the photoconductors Py to Po, the intermediate transfer belt B, and other components rotate.

The photoconductors Py to Po are driven by a drive source (not illustrated).

The charging devices CCy to CCo receive a preset voltage and charge the surfaces of the respective photoconductors Py to Po.

The exposure devices LPHy to LPHo, which are examples of latent-image forming units and which are also examples of light-emitting devices, respectively output laser beams Ly, Lm, Lc, Lk, and Lo for writing latent images in accordance with control signals from the controller C, thereby writing electrostatic latent images on the charged surfaces of the photoconductors Py to Po.

The developing devices Gy to Go develop the electrostatic latent images on the surfaces of the respective photoconductors Py to Po.

The toner cartridges Ky to Ko supply the developers to the respective developing devices Gy to Go, which consume the developers in the developing process.

The first transfer rollers T1y to T1o receive a first transfer voltage having a polarity opposite to the charging polarity of the developers, so that the visible images on the surfaces of the photoconductors Py to Po are transferred onto the intermediate transfer belt B.

The photoconductor cleaners CLy to CLo clean the surfaces of the respective photoconductors Py to Po by removing the developers that remain on the surfaces of the photoconductors Py to Po after the first transfer process.

The intermediate transfer belt B causes O, Y, M, C, and K images to be transferred thereto in that order when the intermediate transfer belt B passes through first transfer regions in which the intermediate transfer belt B faces the photoconductors Py to Po, and then passes through a second transfer region Q4 in which the intermediate transfer belt B faces the second transfer device T2. When a monochrome image is to be formed, an image of a single color is transferred onto the intermediate transfer belt B and transported toward the second transfer region Q4.

The recording sheets S are fed from one of the paper feed trays TR1 to TR3 by the corresponding pick-up roller Rp in accordance with, for example, the size of the received image information, designation of the recording sheets S, and the sizes and types of the recording sheets S that are stored.

The separation rollers Rs separate the recording sheets S fed by the pick-up roller Rp from each other.

The deburring device Bt applies a preset pressure to each recording sheet S that passes therethrough to deburr the recording sheet S.

The double-feeding detection device Jk detects the thickness of the recording sheets S that pass therethrough to detect double feeding of the recording sheets S.

The correction rollers Rc correct a skew of each recording sheet S that passes therethrough by bringing the recording sheet S into contact with a wall surface (not illustrated).

The registration rollers Rr feed the recording sheet S at a time corresponding to the time at which the images on the surface of the intermediate transfer belt B reach the second transfer region Q4.

The sheet guide SG1 guides the recording sheet S fed by the registration rollers Rr to the second transfer region Q4.

The backup roller T2a of the second transfer device T2 receives a preset second transfer voltage having the same polarity as the charging polarity of the developers through the contact roller T2c, so that the images on the intermediate transfer belt B are transferred onto the recording sheet S.

The belt cleaner CLB cleans the intermediate transfer belt B by removing the developers that remain on the surface of the intermediate transfer belt B after the images are transferred in the second transfer region Q4.

The transport belts HB hold the recording sheet S to which the images have been transferred by the second transfer device T2 on the surfaces thereof, and transport the recording sheet S downstream.

The fixing device F includes a heating roller Fh, which is an example of a heating member, and a pressing roller Fp, which is an example of a pressing member. A heater h, which is an example of a heat source, is disposed in the heating roller Fh. The fixing device F heats the recording sheet S that passes through a fixing region Q5, in which the heating roller Fh and the pressing roller Fp are in contact with each other, while pressing the recording sheet S, thereby fixing the unfixed images on the surface of the recording sheet S to the recording sheet S. The heating roller Fh and the pressing roller Fp constitute a fixing member Fp, Fh according to the exemplary embodiment.

The test device IS reads an image on the recording sheet S that has passed through the fixing device F and detects an image defect.

When the recording sheet S that has passed through the test device IS is to be subjected to double-sided printing, the first gate GT1 is activated so that the recording sheet S is transported to the reversing path SH2, transported in a switchback manner along the switchback path SH4, and fed to the registration rollers Rr again along the transport path SH, and printing is performed on a second surface of the recording sheet S.

When the recording sheet S is to be output onto the output tray TRh face-up, that is, such that the surface on which an image is recorded faces upward, the recording sheet S is transported along the transport path SH and output onto the output tray TRh by the output rollers Rh.

When the recording sheet S is to be output face-down, that is, such that the surface on which the image is recorded faces downward, the recording sheet S is temporarily transported from the transport path SH to the reversing path SH2. After the trailing end of the recording sheet S in the transporting direction has passed the second gate GT2, forward rotation of the switchback rollers Rb is stopped. Then, the second gate GT2 is switched and the switchback rollers Rb are rotated in the reverse direction so that the recording sheet S is transported to the output tray TRh along the connection path SH3.

The output recording sheet S is placed on the output tray TRh.

### Description of Image Reading Device

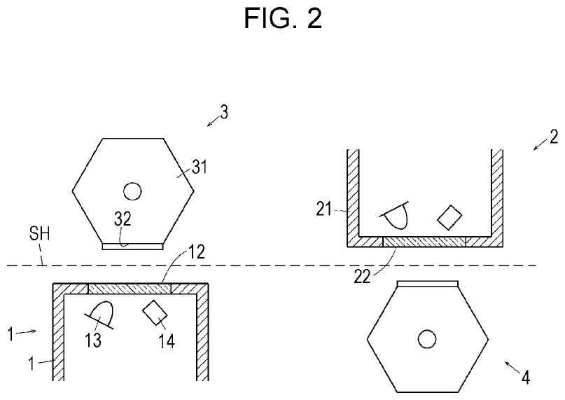

FIG. 2 illustrates the test device according to the exemplary embodiment.

Referring to FIG. 2, the test device IS according to the exemplary embodiment includes an upstream sensor unit 1, which is an example of a first reading unit, and a downstream sensor unit 2, which is an example of a second reading unit.

The upstream sensor unit 1 according to the exemplary embodiment includes a first housing 11 having a window-shaped first reading surface 12 that faces the transport path SH at the top end of the housing 11. A first light 13, which is an example of an illumination unit, and a first image sensor 14, which is an example of a reading element, are disposed inside the first reading surface 12. The upstream sensor unit 1 according to the exemplary embodiment is capable of reading a lower surface of the recording sheet S with the first image sensor 14 when the recording sheet S is transported along the transport path SH.

In the exemplary embodiment, the upstream sensor unit 1 and the downstream sensor unit 2 are arranged to be inverted relative to each other with the transport path SH at the center, but have similar structures. Accordingly, the downstream sensor unit 2 is capable of reading an upper surface of the recording sheet S when the recording sheet S is transported along the transport path SH.

An upstream calibration unit 3, which is an example of a first calibrating unit, is disposed to face the upstream sensor unit 1 with the transport path SH disposed therebetween. The upstream calibration unit 3 includes a first rotating drum 31, which is an example of a rotating unit. A first calibration plate 32, which is an example of a calibration member, is supported on an outer surface of the first rotating drum 31. The first calibration plate 32 is a plate-shaped member having a surface in a color that serves as a reference in a reading process performed by the first image sensor 14, and is composed of a plate in white, which is an example of a reference color, in the exemplary embodiment. The first rotating drum 31 causes the first calibration plate 32 to face the first reading surface 12 when the first image sensor 14 is calibrated before the recording sheet S is transported, and rotates the first calibration plate 32 to a position at which the first calibration plate 32 does not face the first reading surface 12 to prevent the first calibration plate 32 from being soiled or damaged when the recording sheet S is transported and subjected to the reading process.

A downstream calibration unit 4, which is an example of a second calibrating unit, is disposed to face the downstream sensor unit 2 with the transport path SH disposed therebetween. In the exemplary embodiment, the upstream calibration unit 3 and the downstream calibration unit 4 are arranged to be inverted relative to each other with the transport path SH at the center, but have similar structures.

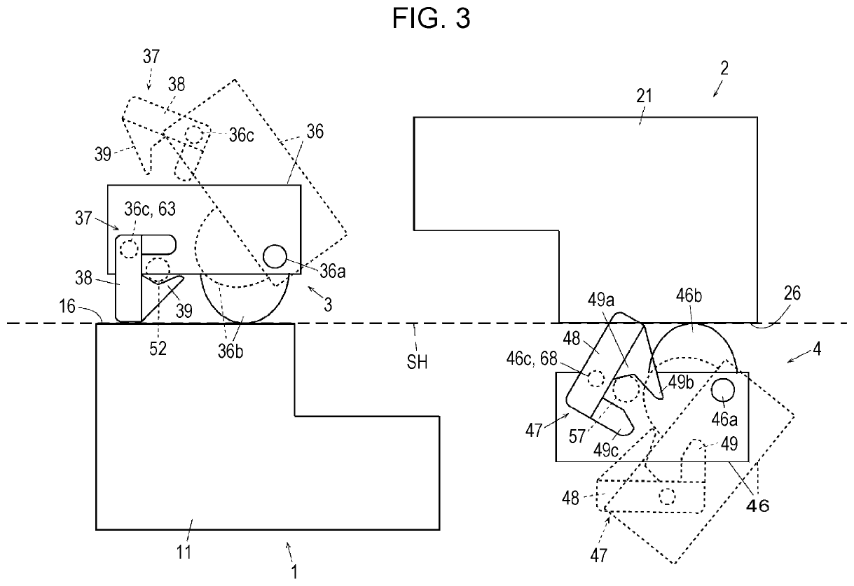

FIG. 3 illustrates operation units of the test device according to the exemplary embodiment.

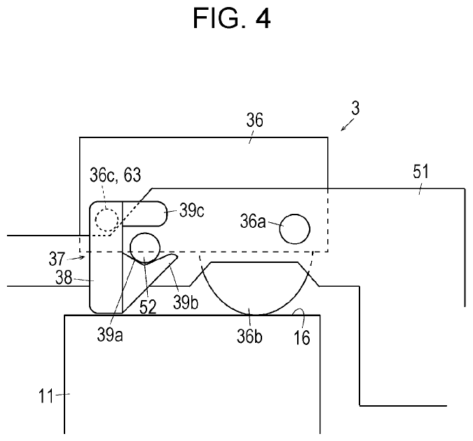

FIG. 4 illustrates the relationship between the upstream sensor unit and a frame unit.

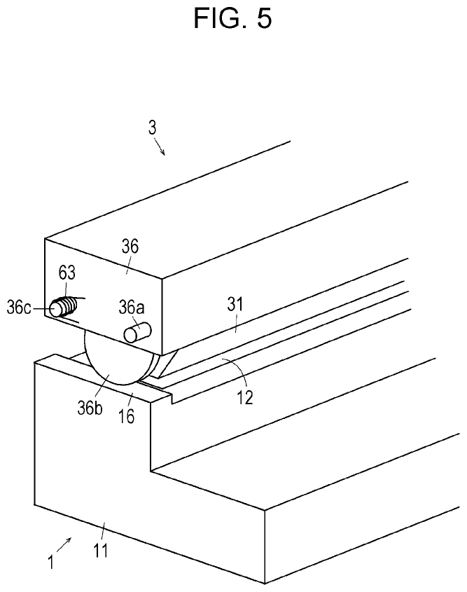

FIG. 5 is a perspective view of an end portion of the upstream sensor unit.

Referring to FIGS. 3 to 5, the upstream calibration unit 3 includes a first housing 36, which is an example of a housing. A frame plate 51, which is an example of a frame of the finisher U3, is disposed in front of the first housing 36. The first housing 36 of the upstream calibration unit 3 is rotatably supported on the frame plate 51 by a first rotating shaft 36a at a lower right end of the first housing 36.

Thus, the upstream calibration unit 3 according to the exemplary embodiment is supported such that the upstream calibration unit 3 is movable between a closing position (position shown by solid lines in FIG. 3) at which the transport path SH is closed and at which the first rotating drum 31 faces the first reading surface 12, and an opening position (position shown by dashed lines in FIG. 3) at which the upstream calibration unit 3 is separated from the first reading surface 12 and at which the transport path SH is opened.

A first positioning projection 36b, which is an example of a first part to be positioned, is provided in a lower right section of the first housing 36. The first positioning projection 36b extends toward the upstream sensor unit 1 disposed below the first housing 36. The first positioning projection 36b according to the exemplary embodiment includes a curved surface on a bottom end portion thereof. An end (bottom end) of the first positioning projection 36b is disposed below the bottom end of the first rotating drum 31.

A first handle shaft 36c, which is an example of a support for an operation unit, is supported at a lower left end of the first housing 36. A first handle 37, which is an example of a first operation unit, is supported by the first handle shaft 36c.

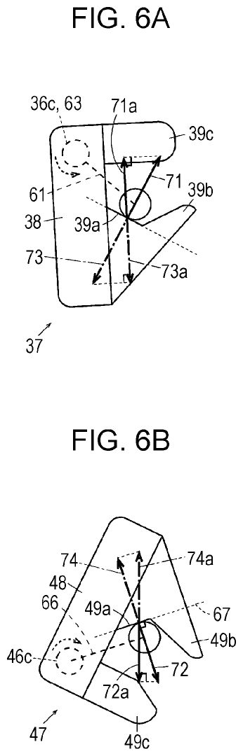

FIGS. 6A and 6B illustrate forces applied to handles according to the exemplary embodiment, wherein FIG. 6A illustrates forces applied to the first handle, and FIG. 6B illustrates forces applied to a second handle.

Referring to FIGS. 3 to 6A, the first handle 37 according to the exemplary embodiment includes a first holding portion 38 capable of being held and operated by an operator and a first latch portion 39, which is an example of a hook portion.

The first latch portion 39 is capable of retaining the upstream calibration unit 3 at the closing position by being latched to a first retaining projection 52, which is an example of a first retaining unit supported by the frame plate 51. The first latch portion 39 according to the exemplary embodiment includes a first retaining portion 39a that comes into contact with the first retaining projection 52 when the upstream calibration unit 3 is at the closing position. The first retaining portion 39a according to the exemplary embodiment is formed such that a surface thereof extends in a direction parallel to a first imaginary line 61 connecting the first handle shaft 36c and the first retaining projection 52 when the upstream calibration unit 3 is at the closing position.

A first stopper portion 39b is formed outside the first retaining portion 39a such that the first stopper portion 39b is bent upward from the surface of the first retaining portion 39a. The first stopper portion 39b prevents the first retaining projection 52 from being released from the first latch portion 39 when the operator accidentally touches the first handle 37 and the first handle 37 is slightly moved. A first guide portion 39c that guides the first retaining projection 52 toward the first retaining portion 39a is disposed to face the first retaining portion 39a and the first stopper portion 39b across the first retaining projection 52.

A first torsion spring 63, which is an example of a first applying unit, is disposed on the first handle shaft 36c. The first torsion spring 63 applies a force that pushes the first handle 37 counterclockwise as illustrated in FIGS. 3 and 6A.

Referring to FIGS. 3 to 5, a first positioning portion 16, which is an example of a positioning part, is formed at each of front and back ends of the first housing 11 of the upstream sensor unit 1. The first positioning portion 16 has an upper surface disposed above the first reading surface 12. The first positioning projection 36b of the upstream calibration unit 3 is capable of coming into contact with the first positioning portion 16 when the upstream calibration unit 3 is moved to the closing position.

In the exemplary embodiment, the first positioning portion 16 may be constituted by a portion of the first housing 11, but is not limited to this. For example, a separate member that corresponds to the first positioning portion 16 may be fixed to the first housing 11 with a screw or by welding.

In the exemplary embodiment, as described above, the downstream sensor unit 2 and the upstream sensor unit 1 are arranged to be inverted relative to each other, but have similar structures. Therefore, the downstream sensor unit 2 includes a second housing 21, a second reading surface 22, and a second positioning portion 26 that are structured similarly to the first housing 11, the first reading surface 12, and the first positioning portion 16, respectively.

The downstream calibration unit 4 and the upstream calibration unit 3 are arranged to be inverted relative to each other, but have similar structures. Therefore, the downstream calibration unit 4 includes a second housing 46, a second rotating shaft 46a, a second positioning projection 46b that is an example of a second part to be positioned, a second handle shaft 46c, and a second handle 47 that are structured similarly to the first housing 36, the first rotating shaft 36a, the first positioning projection 36b, the first handle shaft 36c, and the first handle 37, respectively, of the upstream calibration unit 3.

Referring to FIG. 6B, in the exemplary embodiment, similarly to the first handle 37, the second handle 47, which is an example of a second operation unit, includes a second retaining portion 49a formed such that a surface thereof extends in a direction 67 parallel to a second imaginary line 66 connecting the second handle shaft 46c and a second retaining projection 57 when the upstream calibration unit 3 is at the closing position. In the exemplary embodiment, the second imaginary line 66 is closer to a horizontal line than the first imaginary line 61; in other words, an inclination angle of the second imaginary line 66 with respect to a horizontal direction is less than that of the first imaginary line 61.

Therefore, a second component 72a of a second force 72 in the direction of gravity, the second force 72 being applied to a contact surface between the second retaining projection 57 and the second retaining portion 49a by a second torsion spring (example of a second applying unit) 68, is greater than a first component 71a of a first force 71 in the direction of gravity, the first force 71 being applied to a contact surface between the first retaining projection 52 and the first retaining portion 39a by the first torsion spring 63. In the exemplary embodiment, the second component 72a in the direction of gravity is set so that the second component 72a is greater than the first component 71a in the direction of gravity by an amount corresponding to the weight of the downstream calibration unit 4.

### Operation of Exemplary Embodiment

In the test device IS according to the exemplary embodiment having the above-described structure, the calibration units 3 and 4 rotate with respect to the sensor units 1 and 2, respectively, between the opening positions and the closing positions thereof. When the calibration units 3 and 4 are at the closing positions thereof, the positioning projections 36b and 46b are positioned in contact with the positioning portions 16 and 26 of the sensor units 1 and 2, respectively.

According to the structure described in Patent Document 1, the built-in image sensor (200) and the setting unit (210) are arranged such that one of the built-in image sensor (200) and the setting unit (210) is supported by a drawing unit, referred to as a drawer, that is capable of being pulled out of and inserted into the image forming apparatus in the front-back direction. In the structure described in Patent Document 1, the setting unit (210), which is a small structural object, is provided on the drawer that is pulled out. Therefore, according to the related art described in Patent Document 1, when a sheet is jammed between the built-in image sensor (200) and the setting unit (210), the setting unit (210) provided on the drawer is pulled out to enable removal of the jammed sheet.

In the structure of the related art including the drawer as described in Patent Document 1, the drawer is positioned with respect to a frame of the image forming apparatus on which the built-in image sensor (200) is supported, and the setting unit (210) is positioned with respect to the drawer. Therefore, the error in the position of the setting unit (210) with respect to the built-in image sensor (200) is increased by an amount corresponding to the positional error of the drawer, and there is a limit to the extent to which the error can be reduced. According to Patent Document 1, calibration is performed by using, for example, a white reference surface (232) on the reference roller (226) of the setting unit (210), and therefore the positional error causes a reduction in the calibration accuracy and leads to a reduction in the accuracy of detection of image defects.

In contrast, in the test device IS according to the exemplary embodiment, the positioning projections 36b and 46b of the calibration units 3 and 4 are respectively positioned in contact with the positioning portions 16 and 26 of the sensor units 1 and 2.

In particular, in the exemplary embodiment, the positioning projections 36b and 46b of the calibration units 3 and 4 are constituted by portions of the housings 36 and 46, respectively, and the positioning portions 16 and 26 of the sensor units 1 and 2 are constituted by portions of the housings 11 and 21, respectively. In the exemplary embodiment, the positioning projections 36b and 46b are respectively in direct contact with the positioning portions 16 and 26.

In addition, according to the exemplary embodiment, the calibration units 3 and 4 may be moved to the opening positions thereof by rotating the handles 37 and 47.

In addition, in the exemplary embodiment, the torsion springs 63 and 68 respectively apply the first and second forces 71 and 72 by which the latch portions 39 and 49 push the retaining projections 52 and 57, respectively. Therefore, the latch portions 39 and 49 respectively receive first and second reaction forces 73 and 74. A component 73a of the first reaction force 73 in the direction of gravity serves a force that pushes the first latch portion 39 downward, that is, a force that pushes the upstream calibration unit 3 toward the upstream sensor unit 1. A component 74a of the second reaction force 74 in the direction of gravity serves as a force that pushes the second latch portion 49 upward, that is, a force that pushes the downstream calibration unit 4 toward the downstream sensor unit 2.

Thus, the components 73a and 74a of the reaction forces 73 and 74 in the direction of gravity serve as forces applied in directions in which the positioning projections 36b and 46b approach the positioning portions 16 and 26, respectively, and the positioning reliability is higher than when the reaction forces 73 and 74 are applied in directions opposite to the above-described directions.

In addition, in the exemplary embodiment, the second imaginary line 66 is closer to a horizontal line than the first imaginary line 61, and the component 74a of the second reaction force 74 in the direction of gravity applied to the second retaining portion 49a is greater than the component 73a of the reaction forces 73 in the direction of gravity by an amount corresponding to the weight of the downstream calibration unit 4. Therefore, also in the downstream calibration unit 4, which receives a force in a direction away from the downstream sensor unit 2 due to gravity, the second torsion spring 68 that exerts the same force as the first torsion spring 63 in the upstream calibration unit 3 may be used to apply a sufficient force for bringing the second positioning projection 46b into contact with the second positioning portion 26.

In the exemplary embodiment, when the calibration units 3 and 4 are moved from the opening positions to the closing positions thereof, the operator may manually move the calibration units 3 and 4 toward the closing positions without holding the latch portions 39 and 49, so that the guide portions 39c and 49c of the latch portions 39 and 49 come into contact with the retaining projections 52 and 57 and that the latch portions 39 and 49 rotate against the forces of the torsion springs 63 and 68. Then, when the retaining projections 52 and 57 are guided toward the retaining portions 39a and 49a, the latch portions 39 and 49 are returned to the original positions by the forces of the torsion springs 63 and 68, and the retaining portions 39a and 49a come into contact with the retaining projections 52 and 57 so that the retaining projections 52 and 57 are retained by the latch portions 39 and 49. Thus, the calibration units 3 and 4 may be returned to the closing positions without operating the latch portions 39 and 49.

### Modifications

Although an exemplary embodiment of the present disclosure have been described in detail, the present disclosure is not limited to the above-described exemplary embodiment, and various modifications are possible within the gist of the present disclosure described in the claims. Modifications (H01) to (H06) of the present disclosure will now be described.

(H01) Although the printer U is described as an example of an image forming apparatus in the above-described exemplary embodiment, the image forming apparatus is not limited to this, and may be, for example, a copy machine, a facsimile machine, or a multifunction machine having some or all of the functions of these machines. Also, the image forming apparatus is not limited to an electrophotographic image forming apparatus, and may be any image forming apparatus, such as an inkjet or thermal transfer image forming apparatus.

(H02) Although the printer U uses developers of five colors in the above-described exemplary embodiment, the image forming apparatus is not limited to this, and may be, for example, a monochrome image forming apparatus or a multicolor image forming apparatus that uses four or less or six or more colors.

(H03) Although the endless band-shaped intermediate transfer belt B is described as an example of an image carrier in the above-described exemplary embodiment, the image carrier is not limited to this. The image carrier may be, for example, a cylindrical intermediate transfer drum, a photoconductor drum, or a photoconductor belt. Also, the intermediate transfer body may be omitted, and an image may be recorded on a recording sheet S directly from a photoconductor.

(H04) Although the latch portions 39 and 49 are provided on the calibration units 3 and 4, respectively, and the retaining projections 52 and 57 are provided on the frame plate 51 in the above-described exemplary embodiment, the arrangement is not limited to this. The retaining projections 52 and 57 may be provided on the calibration units 3 and 4, respectively, and the latch portions 39 and 49 may be provided on the frame plate 51.

(H05) Although the upstream sensor unit 1 and the downstream sensor unit 2 are provided to read images on both sides in the above-described exemplary embodiment, the structure is not limited to this. When only a print surface is to be read, the structure may be such that only the downstream sensor unit 2 is provided.

(H06) Although the second imaginary line 66 may be closer to a horizontal line than the first imaginary line 61 in the above-described exemplary embodiment, the arrangement is not limited to this. The first imaginary line 61 and the second imaginary line 66 may extend parallel to each other, or the first imaginary line 61 may be closer to a horizontal line than the second imaginary line 66.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))

An image reading device including:
a reading unit that reads an image on a surface of a medium; and
a calibrating unit that is disposed to face the reading unit with the medium disposed therebetween and that calibrates the reading unit,
wherein the calibrating unit is supported such that the calibrating unit is movable about a rotating shaft between a closing position at which the calibrating unit faces the reading unit and an opening position at which the calibrating unit is separated from the reading unit, and
wherein the calibrating unit is positioned with respect to the reading unit when the calibrating unit is moved to the closing position.
   (((2))

The image reading device according to (((1))),
wherein the reading unit is not supported by a drawing unit that is pulled out and inserted in a width direction of the medium.
   (((3))

The image reading device according to (((1))) or (((2))), further comprising:
a positioning part provided on the reading unit; and
a part to be positioned that is provided on the calibrating unit and positioned in direct contact with the positioning part.
   (((4))

The image reading device according to (((3))),
wherein the positioning part is constituted by a portion of a housing of the reading unit, and
wherein the part to be positioned is constituted by a portion of a housing of the calibrating unit.
   (((5))

The image reading device according to any one of (((1))) to (((4))), further comprising:
an operation unit that is supported by the calibrating unit and that is capable of being operated to move between a retaining position at which the operation unit retains the calibrating unit at the closing position and a releasing position at which the operation unit releases the calibrating unit from the closing position; and
a retaining unit that comes into contact with the operation unit when the calibrating unit is moved to the closing position and when the operation unit is moved to the retaining position.
   (((6))

The image reading device according to (((5))), further comprising:
an applying unit that applies a force that pushes the operation unit toward the retaining position,
wherein the operation unit is configured such that the operation unit receives a reaction force from the retaining unit in response to the force applied by the applying unit on a contact surface between the operation unit at the retaining position and the retaining unit, the reaction force having a component in a direction in which the calibrating unit approaches the reading unit.
   (((7))

The image reading device according to (((6))),
wherein the calibrating unit includes a first calibrating unit disposed to face an upper surface of the medium in a direction of gravity and a second calibrating unit disposed to face a lower surface of the medium in the direction of gravity,
wherein the operation unit includes a first operation unit provided on the first calibrating unit and a second operation unit provided on the second calibrating unit,
wherein the applying unit includes a first applying unit provided on the first calibrating unit and a second applying unit provided on the second calibrating unit, the second applying unit applying a force equal to a force applied by the first applying unit, and
wherein a reaction force received by the second operation unit at a contact surface between the second operation unit and the second retaining unit is greater than a reaction force received by the first operation unit at a contact surface between the first operation unit and the first retaining unit by an amount corresponding to a weight of the second calibrating unit disposed at a lower side in the direction of gravity.
   (((8))

An image forming apparatus including:
a recording unit that records an image on a medium; and
the image reading device according to any one of (((1))) to (((7))) that reads the image recorded on the medium by the recording unit.

What is claimed is:

1. An image reading device comprising:
a reading unit that reads an image on a surface of a medium; and
a calibrating unit that is disposed to face the reading unit with the medium disposed therebetween and that calibrates the reading unit,
wherein the calibrating unit is supported such that the calibrating unit is movable about a rotating shaft between a closing position at which the calibrating unit faces the reading unit and an opening position at which the calibrating unit is separated from the reading unit, and
wherein the calibrating unit is positioned with respect to the reading unit when the calibrating unit is moved to the closing position.

2. The image reading device according to claim 1,
wherein the reading unit is not supported by a drawing unit that is pulled out and inserted in a width direction of the medium.

3. The image reading device according to claim 1, further comprising:
a positioning part provided on the reading unit; and
a part to be positioned that is provided on the calibrating unit and positioned in direct contact with the positioning part.

4. The image reading device according to claim 3,
wherein the positioning part is constituted by a portion of a housing of the reading unit, and
wherein the part to be positioned is constituted by a portion of a housing of the calibrating unit.

5. The image reading device according to claim 1, further comprising:
an operation unit that is supported by the calibrating unit and that is capable of being operated to move between a retaining position at which the operation unit retains the calibrating unit at the closing position and a releasing position at which the operation unit releases the calibrating unit from the closing position; and
a retaining unit that comes into contact with the operation unit when the calibrating unit is moved to the closing position and when the operation unit is moved to the retaining position.

6. The image reading device according to claim 5, further comprising:
an applying unit that applies a force that pushes the operation unit toward the retaining position,
wherein the operation unit is configured such that the operation unit receives a reaction force from the retaining unit in response to the force applied by the applying unit on a contact surface between the operation unit at the retaining position and the retaining unit, the reaction force having a component in a direction in which the calibrating unit approaches the reading unit.

7. The image reading device according to claim 6,
wherein the calibrating unit includes a first calibrating unit disposed to face an upper surface of the medium in a direction of gravity and a second calibrating unit disposed to face a lower surface of the medium in the direction of gravity,
wherein the operation unit includes a first operation unit provided on the first calibrating unit and a second operation unit provided on the second calibrating unit,
wherein the applying unit includes a first applying unit provided on the first calibrating unit and a second applying unit provided on the second calibrating unit, the second applying unit applying a force equal to a force applied by the first applying unit, and
wherein a reaction force received by the second operation unit at a contact surface between the second operation unit and the second retaining unit is greater than a reaction force received by the first operation unit at a contact surface between the first operation unit and the first retaining unit by an amount corresponding to a weight of the second calibrating unit disposed at a lower side in the direction of gravity.

8. An image forming apparatus comprising:
a recording unit that records an image on a medium; and
the image reading device according to claim 1 that reads the image recorded on the medium by the recording unit.

9. An image forming apparatus comprising:
a recording unit that records an image on a medium; and
the image reading device according to claim 2 that reads the image recorded on the medium by the recording unit.

10. An image forming apparatus comprising:
a recording unit that records an image on a medium; and
the image reading device according to claim 3 that reads the image recorded on the medium by the recording unit.

11. An image forming apparatus comprising:
a recording unit that records an image on a medium; and
the image reading device according to claim 4 that reads the image recorded on the medium by the recording unit.

12. An image forming apparatus comprising:
a recording unit that records an image on a medium; and
the image reading device according to claim 5 that reads the image recorded on the medium by the recording unit.

13. An image forming apparatus comprising:
a recording unit that records an image on a medium; and
the image reading device according to claim 6 that reads the image recorded on the medium by the recording unit.

14. An image forming apparatus comprising:
a recording unit that records an image on a medium; and
the image reading device according to claim 7 that reads the image recorded on the medium by the recording unit.

15. An image reading device comprising:
reading means for reading an image on a surface of a medium; and
calibrating means, disposed to face the reading means with the medium disposed therebetween, for calibrating the reading means,
wherein the calibrating means is supported such that the calibrating means is movable about a rotating shaft between a closing position at which the calibrating means faces the reading means and an opening position at which the calibrating means is separated from the reading means, and
wherein the calibrating means is positioned with respect to the reading means when the calibrating means is moved to the closing position.
